(19) United States
(12) Patent Application Publication
(10) Pub. No.: US 2003/0051182 A1
(43) Pub. Date: Mar. 13, 2003

(54) Method and apparatus for cognitive power management of video displays

(76) Inventors: Aaron M. Tsirkel, San Jose, CA (US); Guy M. Therien, Beaverton, OR (US); Daniel Lenehan, Los Altos Hills, CA (US)

Correspondence Address: Tarek N. Fahmi, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/952,113

(22) Filed: Sep. 13, 2001

(51) Int. Cl. G06F 1/26; G06F 1/32

(52) U.S. Cl. 713/320

(57) ABSTRACT

A power management apparatus includes a sensor and a display coupled with the sensor. The display is powered off when the sensor detects absence of a user and the display is powered on when the sensor detects presence of the user.

### FIELD OF THE INVENTION

The present invention relates generally to field of power management. More specifically, the invention relates to a method and an apparatus for power management for displays.

### BACKGROUND

Due to the tremendous amount of energy consumed by displays when operating, different approaches are used to reduce power consumption (and energy use) of displays during idle periods. The idea behind power management is to reduce the overall power consumption of systems, including the display, when user walks away from the system or stops using it after a period of time. Also, when the system is in use, inactive devices within the system are power managed or turned off.

One approach is based on a Display Power Management System (DPMS) protocol. DPMS is used to selectively shut down parts of the display's circuitry after a period of inactivity. With a motherboard and display that support DPMS, power consumption can be greatly reduced. The motherboards that support DPMS often have a BIOS (basic input/output system) setting to enable the power consumption option. The BIOS setting controls a length of time the system must be idle (i.e., no activity detected from the user) for the display to be powered off. The idle time (or time out value) is specified in minutes or hours, or it may be set to “Disabled” or “Never”. The system then tries to detect user's activity including, for example, keyboard input and mouse movement. When there is no user's activity after the expiration of the time out value, the system sends appropriate control signals to the display to so that it is powered off. When the system detects user's activity, the system sends appropriate control signals to the display so that it is powered on.

Another approach to power management is by setting user's preference using the operating system or application software. For example, using Microsoft Windows 98, power to the display can be managed by setting a power off option in a power management properties menu to a certain fixed time out value. The time out value may be set to any value provided in a pop-up window ranging from a minimum value of 1 minute to a maximum value of “never”. The time out value is static and remains the same until another time out value is selected.

One disadvantage of the time-based power management schemes described above is that if used improperly (such as telling the system to shut down after 1 minute of idle time), it can result in a lot of wear and tear on the display's internal components, reducing the display life and causing user unpleasant experience. Another disadvantage with the time-based power management schemes is that when the value is too small, the display can keep being powered off even when the user present.

### BRIEF DESCRIPTION OF THE DRAWINGS

The present invention is illustrated by way of example, and not limitation, in the figures of the accompanying drawings in which like references indicate similar elements and in which:

FIG. 1 is a timing diagram illustrating a prior art approach to powering off a display.

FIG. 2 is an illustration of one embodiment a system used to conserve power consumption by a display.

FIG. 3 is a flow diagram illustrating one embodiment of a power management process using a sensor.

FIGS. 4A and 4B are timing diagrams to illustrate one example of powering off a display using a sensor-based method of the present invention in comparison with a prior art approach to powering off the display.

FIG. 5 is a flow diagram illustrating one embodiment of a power management process using a sensor-based method in conjunction with a time-based method.

FIG. 6 is a block diagram illustrating one embodiment of a driver-based user detection system using a sensor.

FIG. 7 is an example of a computer system implemented with the sensor described in the present invention.

### DETAILED DESCRIPTION

A method of using a sensor to detect presence of a user to manage power consumption of a system is disclosed. The sensor monitors absence or presence of the user and generate control signals to allow powering off or powering on a display.

Typically, at boot time, the display is powered on. Then the time based power management scheme is invoked. Any triggering event such as, for example, a keyboard input or a movement of a mouse, resets the time out value to zero. When the time out value expires prior to any triggering event, the display is powered off. While the display is powered off, any triggering event causes the display to be powered on and the time out value reset to zero.

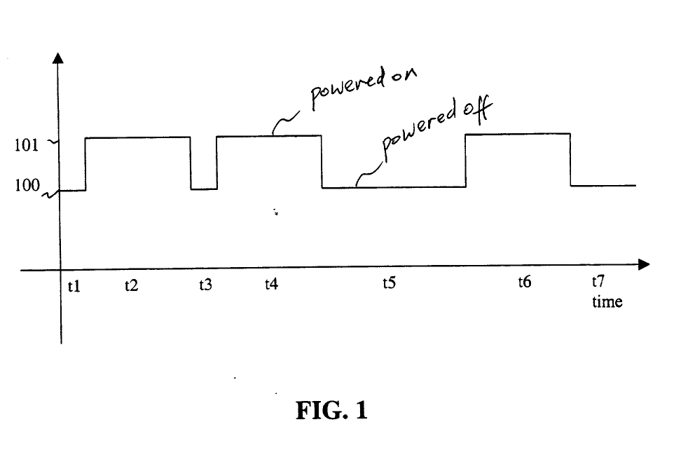

FIG. 1 is a timing diagram illustrating one example of a prior art approach to powering off a display. Time progresses from the left to the right on the horizontal axis. The vertical axis illustrates two different power states of a display, an active state 101 and an inactive state 100. During the active state 101, the display is powered on, and during the inactive state 100, the display is powered off. Thus, during time intervals t1, t3, t5, and t7 the display is powered off. During time intervals t2, t4, and t6 the display is powered on.

In this example, assuming the display is powered off during the time interval t1. A triggering event occurring at the end of the time interval t1 causes the display to be powered on at the start of the time interval t2. In this example, the triggering event may be a single movement of the mouse or a single keyboard input. The occurrence of the triggering event is interpreted that a user is in front of or near the display, and the time out value is reset to zero. Even though there is no additional triggering event occurring during the time intervals t2, t4, and t6, the display remains powered on until the time out value expires. One disadvantage of the prior art approach is that the length of the time intervals t2, t4, and t6 are the same even though the user may not be in front of the display. Leaving the display powered on without presence of the user means wasted power consumption by the display.

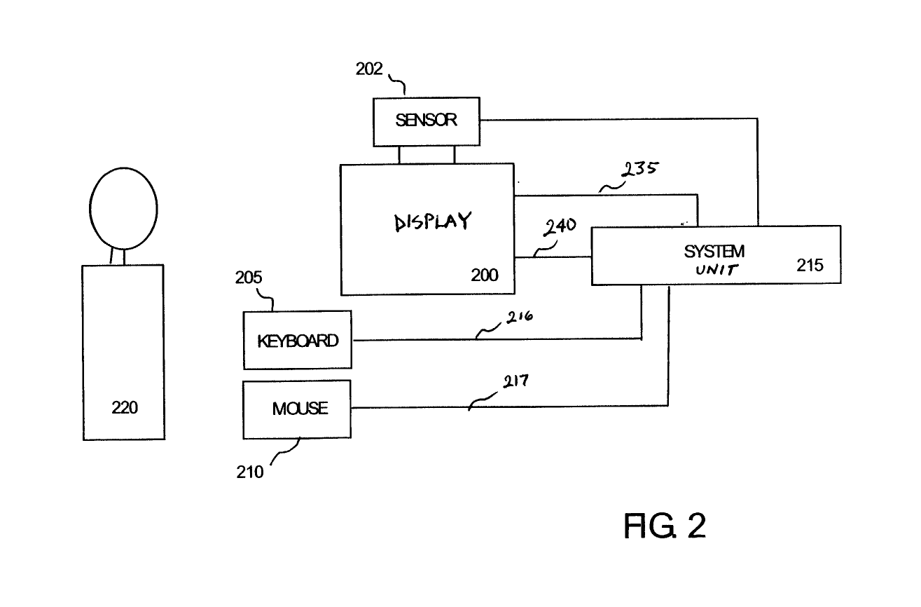

FIG. 2 is an illustration of one embodiment a system used to conserve power consumption by a display. The system includes a system unit 215. A keyboard 205 is connected to the system unit 215 using connection 216. A mouse 210 is connected to the system unit 215 using connection 217. A display 200 is connected to the system unit 215 at a video port (not shown) on the using connection 235. In this example, the display 200 receives its power from the system unit 215 using connection 240. The power to the system unit 215 may be provided by a battery (not shown) as in a portable system, or it may come from an electrical outlet (not shown) as in a desktop system. Typically, a user 220 is positioned near or in front of the display 200.

In one embodiment, a sensor device 202 is used to detect if a user is present in front of or near the display 200. The sensor device 202 may be an infrared thermal sensor device (ITSD) including an infrared thermal sensor. The sensor device 202 is capable of detecting the presence or absence of a user via the detection of the user's heat signature. The sensor device 202 may be set up to sense the change within a certain configurable range and/or parameters (e.g., distance, pulse rate, temperature, events, etc.)

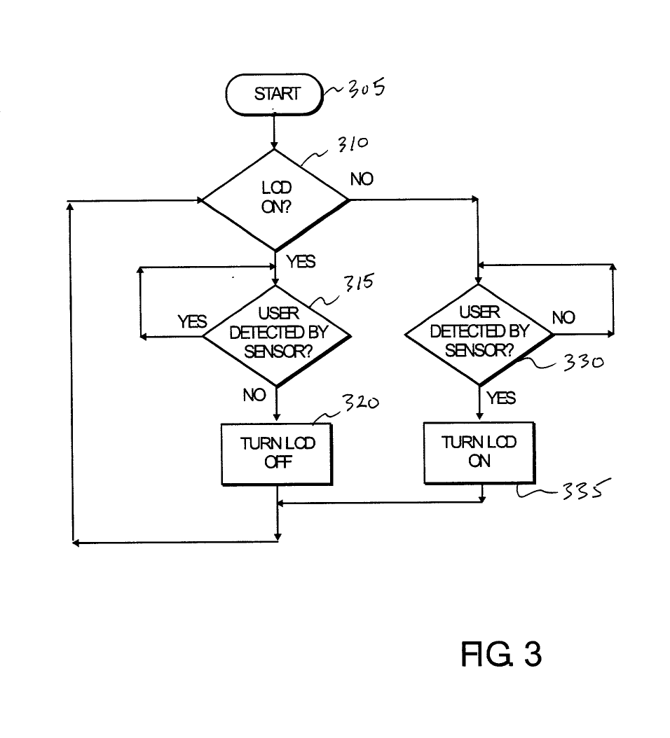

FIG. 3 is a flow diagram illustrating one embodiment of a user detection process. The process is continuous and starts at block 305. At block 310, a determination is made to see if the display is currently powered-on. When the display is powered-on, the process moves to block 315, where a determination is made to see if a user is detected by the sensor. In one embodiment, this determination is performed by detecting a change in the temperature of a “sensing” area in front of the display. Of course, the idea is to sense the temperature generated by the user in front of the display. For example, when a temperature sensed by the sensor is lower than a previously sensed temperature, it is an indication that the user has left the “sensing” area in front of or near the display. Conversely, when the temperature sensed by the sensor is higher than a previously sensed temperature, it is an indication that the user has returned to the “sensing” area.

Thus, when the display is on and the user is detected, the process is in a wait state until there is a change in the temperature. This is illustrated by the operation in block 315 and the looping back to the block 315. From block 315, when the user is not detected (e.g., when the temperature sensed by the sensor is lower than the previously sensed temperature), the display is powered off, as shown in block 320. The user detection process continues at block 310.

From block 310, when the display is currently powered off, the process moves to block 330, where a determination is made to see if a user is detected by the sensor. Similar to the description above, this determination may be performed by detecting a change in the temperature. Thus, when the display is off and the user is not detected, the process is in a wait state until there is a change in the temperature. This is illustrated by the operation in block 330 and the looping back to the block 330. From block 330, when the user is detected (e.g., when the temperature sensed by the sensor is higher than the previously sensed temperature), the display is powered on, as shown in block 335. The user detection process continues at block 310.

Thus, using the process illustrated in FIG. 3, the powering on and powering off of the display is more responsive to presence of the user. When the user leaves the “sensing” area, the display is powered off without having to wait for the time out value to expire. When the user returns to the “sensing” area, the display is powered on.

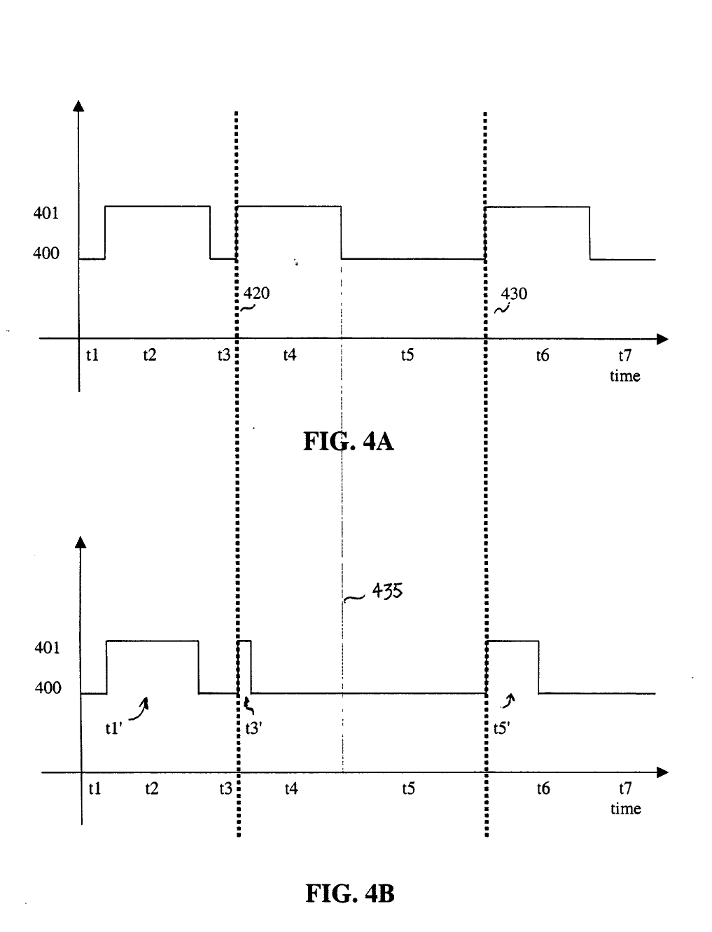

FIG. 4A is a timing diagram representing the prior art approach similar to that illustrated in FIG. 1. FIG. 4B is a timing diagram representing the sensor-based approach of the present invention. FIGS. 4A and 4B are illustrated together for comparison purpose. The dotted lines 420 and 430 represent a beginning and an ending time of a time window used for the comparison. The line 435 is used to illustrate an ending time of the time interval t4 for both FIG. 4A and FIG. 4B. The level 400 represents a power down level, and the level 401 represents a power on level.

Referring to FIG. 4A, the time interval t4 represents the time out value set by the user. The display may be powered on at the beginning of the time interval t4 because an activity is detected from the user. The display remains powered on while receiving no input from the user, even though the user has already left the area soon after a beginning of the time interval t4. The display is powered off at a beginning of the time interval t5. The display remains powered off during the time interval t5 until receiving a user's activity (e.g., keyboard input from the user) at a beginning of the time interval t6. Thus, the power-off time is the length of the time interval t5.

Referring to FIG. 4B, the time intervals t4 and t5 are the same as those in FIG. 4A. The time interval t3′ (t3 prime) is a subset of the time interval t4 and represents a length of time that the display is powered on because the sensor senses presence of the user. In this example, the display is powered off at an end of the time interval t3′ when the user is not detected. The display is powered on at the beginning of the time interval t6 when the user is again detected. Thus, the power-off time is (t5+(t4−t3′)). This is much longer than the time interval t5 illustrated in FIG. 4A. The time interval t1′ (t1 prime) and the time interval t5′ (t5 prime) in FIG. 4B illustrate different power-on time intervals depending on how the user remains detected by the sensor. Note that, in this example, the power-off time using the sensor-based method is generally longer than the power-off time of the prior art method, and the power-on time is generally shorter using the sensor-based method. The sensor-based method eliminates the time between the user's absence and the display being powered off under the prior art time-based approach. Since the display power comprises a large percentage of the power consumed by a typical system, the power savings using the sensor-based method can be significant.

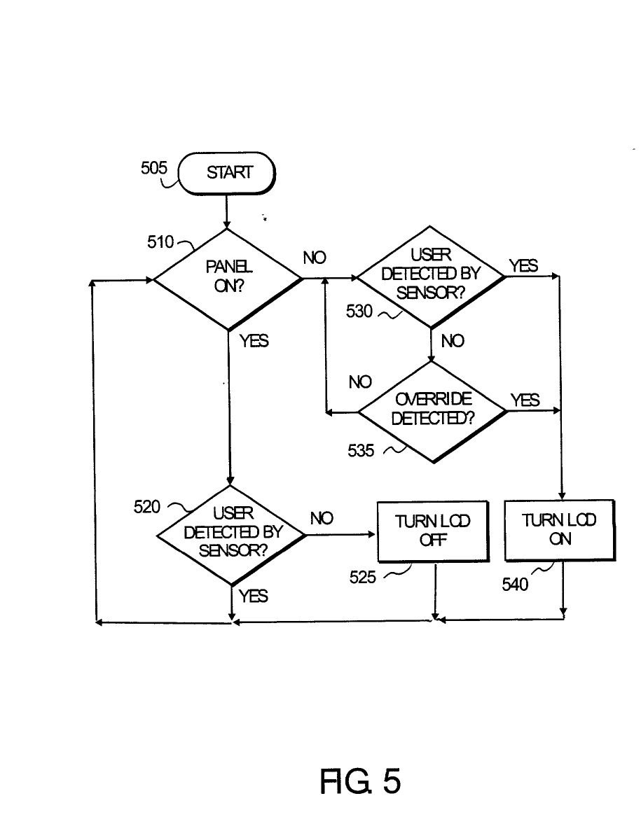

FIG. 5 is a flow diagram illustrating one embodiment of a power management process using a sensor-based method in conjunction with a time-based method. The process is continuous and starts at block 505. At block 510, a determination is made to see if the display is currently powered on. When the display is currently powered on, the time out value is continually reset by user's activity (e.g., keyboard input, mouse movement, etc.). Eventually, the time out value expires if there is no user's activity. Note that the expiration of the time out value may be disabled by software applications such as, for example, DVD player applications. In one embodiment, the time out value is set to a minimum configurable value. This allows a minimum wait time using the time-based method before the sensor-based method takes over.

When the time out value expires, the process moves to block 520. At block 520, a determination is made to see if the sensor detects presence of a user. Note that using the prior art time-based approach described above, the display may be powered off even though the user may still be present. For example, when the time out value is set to one minute, the display can be powered off while the user is viewing data being displayed but not generating any input activity prior to the expiration of the time out value. This situation is avoided by the determination performed in block 520.

From block 520, when the user is detected to be present, the process moves back to block 510 to wait for the length of time specified by the time out value until the user is not detected. From block 520, when the user is not detected (e.g., the user has moved away from the area in front of the display), the process moves to block 525 where the display is powered off. The process continues at block 510.

From block 510, when the display is not currently powered on, the process moves to block 530 where a determination is made to see if the sensor detects presence of the user. When the sensor detects the user, the process moves to block 540 where the display is powered on. The process then continues at block 510.

From block 530, when the sensor does not detect the presence of the user, the process moves to block 535 where a determination is made to see if an override is detected. The override may be any triggering event that causes the display to be powered on. For example, the override may be an input generated the user remotely using a remote controlled mouse. Being in a remote location (e.g., across a room), the user is not detected by the sensor. When an override is not detected, the process moves from block 535 back to block 530 to wait for the sensor to detect the user or to wait for an override to occur. When an override is detected, the process moves from block 535 to block 540 where the display is powered on. The process then continues at block 510.

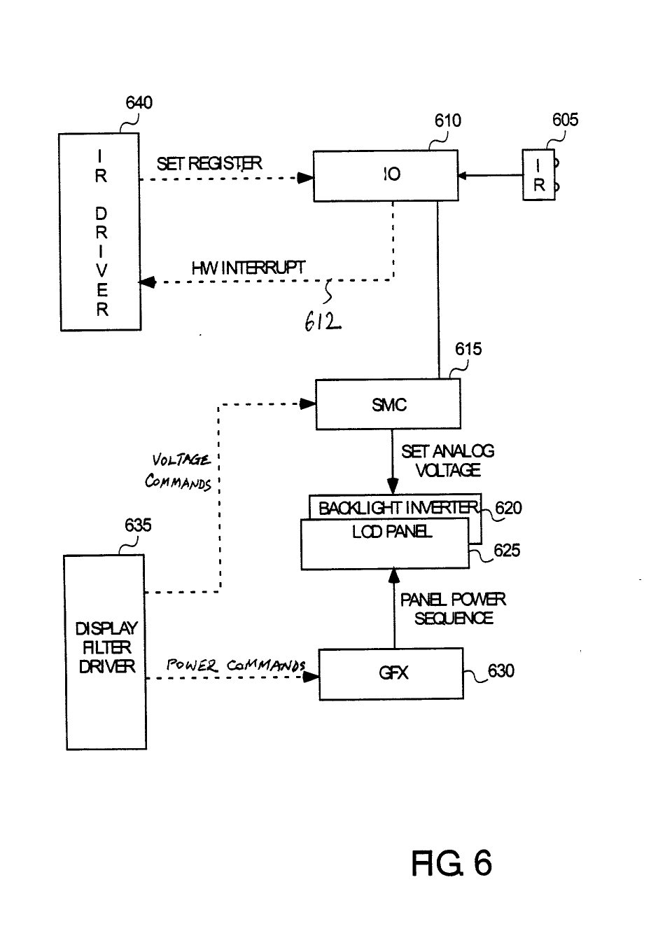

FIG. 6 is a block diagram illustrating one embodiment of a driver-based user detection system using a sensor. The detection system is implemented using drivers and includes an infrared thermal sensor device (ITSD) 605 coupled with an I/O controller 610. The ITSD 605 includes an infrared thermal sensor and latch with a register based programmatic interface.

The I/O controller 610 provides interface (e.g., RS232) for the ITSD 605. The I/O controller 610 may also provide a hardware interrupt interface such that when the sensor on the ITSD 605 detects a change in the user presence state, a hardware interrupt 612 is generated. The I/O controller 610 is coupled with a system management controller 615 that provides analog voltage to a backlight inverter 620. The backlight inverter 620 is coupled with a display panel 625. A graphics controller 630 controls the display panel 625 and power to the backlight inverter 620.

A sensor driver 640 is used to configure the ITSD 605 for sensor signal strength, pulse rate, etc. The sensor driver 640 may be used by a power management program to provide input options to configure the ITSD 605. The input options may then be used to set register values in the I/O controller 610. The sensor driver 640 may also handle hardware interrupt requests generated by the I/O controller 610 by sending signal event to the power management program.

A display filter driver 635 sends commands to the system management controller 615 to program the analog voltage to the backlight inverter 620. The display filter driver 635 also sends power commands to a display subsystem (not shown) to turn on/off power to the display panel 625, the backlight inverter 620, and the graphics controller 630. The display filter driver 635 may be used by the power management program to set the display power when there is a change to a presence state of the user (e.g., the user leaves the area or the user comes back to the area). In this example, the system remains in an idle state until it receives an interrupt generated by the I/O controller 610. The interrupt is generated when the sensor detects a change to the presence state of a user. In an alternative embodiment, the power management program may periodically poll the I/O controller 610 to determine if the sensor in the ITSD 605 detects a change in the user presence state.

Although the above description refers to a temperature-sensing device, other types of sensor may also be used to detect the user's presence. In one embodiment, the sensor is an acoustic (sonic) distance sensor generating sound waves to detect the user's presence. The sound waves are bounced off the user and the distance between the user and the display is calculated. When the distance is beyond a threshold, the user is perceived to have left the “sensing” area, and the display is powered off. While the display is powered off, the sensor continues to send sound waves and detect distances. When the distance found to be within the threshold, the display is powered on.

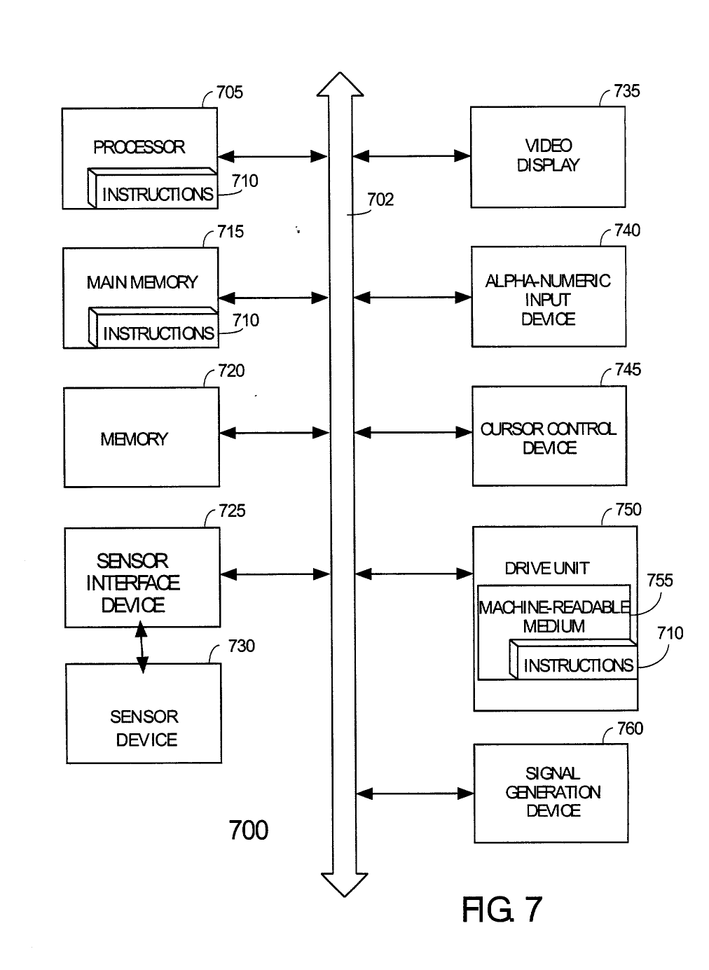

FIG. 7 is an example of a computer system implemented with the sensor described in the present invention. The computer system 700 includes a processing unit 705 coupled with a bus 702. Other devices coupled with the bus includes a video display 735, an alphanumeric input device 740 (e.g., a key board), and a cursor control device 745 (e.g., a mouse). The computer system 700 also includes a sensor device 730 coupled with a sensor device interface 725 to sense absence or presence of the user. The sensor interface device 725 is coupled with the bus 702 to send interrupt signals. Also coupled with the bus 702 is a signal generation device 760 to generate signals in response to the interrupts generated by the sensor interface device 725.

The operations of the various methods of the present invention may be implemented by sequences of computer program instructions 710 which are stored in a memory which may be considered to be a machine readable storage media 755. The memory may be random access memory, read only memory, a persistent storage memory, such as mass storage device 720 or any combination of these devices. Execution of the sequences of instructions 710 causes the processing unit 705 to perform operations according to the present invention, including the operations described in FIG. 3 and/or the operations described in FIG. 5. The instructions 710 may be loaded into a main memory 715 of the computer system from a storage device or from one or more other digital processing systems (e.g. a server computer system) over a network connection. The instructions 710 may be stored concurrently in several storage devices (e.g. DRAM and a hard disk, such as virtual memory). Consequently, the execution of the instructions 710 may be performed directly by the processing unit 705.

In other cases, the instructions 710 may not be performed directly or they may not be directly executable by the processing unit 705. Under these circumstances, the executions may be executed by causing the processing unit 705 to execute an interpreter that interprets the instructions, or by causing the processing unit 705 to execute instructions which convert the received instructions 710 to instructions which can be directly executed by the processing unit 705. In other embodiments, hard-wired circuitry may be used in place of or in combination with software instructions to implement the present invention. Thus, the present invention is not limited to any specific combination of hardware circuitry and software, nor to any particular source for the instructions executed by the computer or digital processing system.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. An apparatus, comprising:
a sensor; and
a display coupled with the sensor such that the display is powered off when the sensor detects absence of a user and the display is powered on when the sensor detects presence of the user.

2. The apparatus of claim 1, wherein the sensor is an infrared thermal sensor.

3. The apparatus of claim 1, further comprising a system unit coupled with the display, wherein when the sensor detects the absence of the user, the sensor generates a signal causing the system unit to power off the display.

4. The apparatus of claim 3, wherein the display is powered off prior to expiration of a time-based display power management time value when absence of the user is detected prior to the expiration of the time-based time value.

5. The apparatus of claim 3, wherein when the sensor detects the presence of the user, the sensor generates a signal causing the system unit to power on the display.

6. The apparatus of claim 5, wherein the display is powered on prior to the user interacting with the system.

7. The apparatus of claim 1, wherein the sensor is an accoustic sensor, wherein the user is present if a distance calculated between the user and the sensor is within a threshold.

8. The apparatus of claim 1, wherein the display is part of a portable sytem or a desktop system.

9. A method, comprising:
powering off a display when a sensor detects absence of a user, the sensor coupled with the display in a computer system; and
powering on the display when the sensor detects presence of the user.

10. The method of claim 9, wherein no interaction with the computer system is required from the user when the display is powered on and presence of the user is detected.

11. The method of claim 9, wherein the display is not powered off while presence of the user is detected even though the user provides no interaction with the computer system.

12. The method of claim 7, wherein the sensor is a thermal sensor or an acoustic sensor.

13. The method of claim 7, wherein the computer system is a portable system or a desktop system.

14. A computer readable medium having stored thereon sequences of instructions which are executable by a system, and which, when executed by the system, cause the system to:
power off a display when a sensor detects absence of a user, the sensor coupled with the display in a computer system; and
power on the display when the sensor detects presence of the user.

15. The computer readable medium of claim 14, wherein no interaction with the computer system is required from the user when the display is powered on and presence of the user is detected.

16. The computer readable medium of claim 14, wherein the display is not powered off while presence of the user is detected even though the user provides no interaction with the computer system.

17. The computer readable medium of claim 10, wherein the sensor is a thermal sensor or an acoustic sensor.

18. The computer readable medium of claim 10, wherein the computer system is a portable system or a desktop system.

19. A system, comprising:
a processor;
a display coupled with the processor;
a sensor coupled with the display;
a memory coupled with the processor and the display, wherein the processor is configured by a set of instructions stored in the memory to power off the display when the sensor detects absence of a user near the display and to power on the display when the sensor detects presence of the user near the display.

20. The system of claim 19, wherein the sensor is configured to detect presence or absence of the user such that when the user is outside a configurable range, the user is considered to be not near the display.

21. The system of claim 19, wherein no interaction is required from the user when the display is powered on and presence of the user is detected.

22. The system of claim 19, wherein the display is not powered off while presence of the user is detected even though the user provides no interaction with the computer system.

23. The system of claim 19, wherein the display is powered off prior to expiration of a time-based display power management time value when absence of the user is detected prior to the expiration of the time-based time value.

24. The system of claim 19, wherein when the sensor detects the presence of the user and the display was powered off, the display is powered on prior to the user interacting with the system.

25. The system of claim 19, wherein the sensor is a thermal sensor or an acoustic sensor.

26. A system, comprising:
means for detecting presence of a user such that:
when a display is powered off and the user's presence is detected, the display is powered on, and
when the display is powered on and the user's presence is not detected, the display is powered off.

27. The system of claim 26, wherein the means for detecting the presence of the user comprises means for configuring a sensing area such that when the user is not in the sensing area, the user is not detected by the means for detecting the presence of the user.
